(19) United States
(12) Patent Application Publication
(10) Pub. No.: US 2025/0289023 A1
(43) Pub. Date: Sep. 18, 2025

(54) FLUENT MATERIAL ROLLER FRAME AND SPINDLE ASSEMBLY

(71) Applicant: Behr Process LLC, Santa Ana, CA (US)

(72) Inventors: Mitchell Barbon, Irvine, CA (US); Darren Wade Stoddart, Huntington Beach, CA (US); Jesse Clemmer, Huntington Beach, CA (US)

(21) Appl. No.: 19/073,966

(22) Filed: Mar. 7, 2025

Related U.S. Application Data
(60) Provisional application No. 63/565,780, filed on Mar. 15, 2024.
(60) Provisional application No. 63/739,165, filed on Dec. 27, 2024.

(51) Int. Cl. B05C 17/02

(52) U.S. Cl. CPC B05C 17/0217

(57) ABSTRACT

A fluent material roller spindle assembly includes a bearing and a chuck rotatably carried on the bearing about a rotational axis established by the bearing. The bearing includes a radially outer bearing surface and a radially inner bearing surface circumscribing the rotational axis, an axially outboard bearing end, and an axially inboard bearing end. The chuck includes a radially outer chuck surface and a radially inner chuck surface circumscribing the rotational axis, an axially outboard chuck end, and an axially inboard chuck end. A bearing portion of the radially inner chuck surface is carried on a corresponding chuck portion of the radially outer bearing surface. A fluent roller frame includes a handle, the spindle assembly, and a wire having a handle portion coupled to the handle, a spindle shaft on which the spindle assembly is rotatably mounted, and an offset portion between the handle portion and the spindle shaft.

This is a non-provisional patent application that claims the benefit of U.S. Provisional Application No. 63/565,780, filed Mar. 15, 2024 and U.S. Provisional Application No. 63/739,165, filed Dec. 27, 2024.

### TECHNICAL FIELD

This disclosure relates generally to apparatuses for applying fluent materials to surfaces and, more particularly, to fluent material roller frames and spindle assemblies for fluent material roller frames.

### BACKGROUND

A paint roller is generally known as a hand-held tool or device that includes a roller cover that absorbs paint and transfers it to a surface by rolling over the surface, and a roller frame to rotatably carry the roller cover about a rotation axis of the roller frame. The roller frame generally includes a handle for gripping by a user, a spindle for rotatably retaining the roller cover on the roller frame about the rotation axis, and a wire having a handle portion coupled to the handle, a spindle shaft on which the spindle is rotatably mounted, and an offset portion between the handle portion and the spindle shaft. Roller covers having a common size but different qualities, such as knaps, materials, and the like, may be applied to and removed from the roller frame to achieve different painting qualities. Roller covers may be reused but are often used once and discarded, whereas roller frames are designed to be reused for many months or years.

Such paint rollers are commercially successful, having been widely used since at least the 1940's. But many paint rollers, particularly mini-rollers, are sold with a roller frame including a spindle with an outer diameter configured to carry only a standard mini-roller cover having a ¼″ inside diameter (ID), but not also a so-called jumbo mini-roller cover having a ¾″ ID. So a consumer must purchase a separate paint roller with a spindle configured to carry the jumbo mini-roller cover.

### SUMMARY

A fluent material roller spindle assembly includes a bearing establishing a rotational axis and including a radially outer bearing surface circumscribing the rotational axis, a radially inner bearing surface circumscribing the rotational axis, an axially outboard bearing end, and an axially inboard bearing end. The fluent material roller spindle assembly also includes a chuck rotatably carried on the bearing about the rotational axis and including a radially outer chuck surface circumscribing the rotational axis, a radially inner chuck surface circumscribing the rotational axis, an axially outboard chuck end, and an axially inboard chuck end. A bearing portion of the radially inner chuck surface of the chuck is carried on a corresponding chuck portion of the radially outer bearing surface of the bearing.

A fluent roller frame includes a handle, the above-described spindle assembly, and a wire having a handle portion coupled to the handle, a spindle shaft on which the spindle assembly is rotatably mounted, and an offset portion between the handle portion and the spindle shaft.

### BRIEF DESCRIPTION OF THE DRAWINGS

FIG. 1 is a plan view according to an illustrative embodiment of a fluent material roller frame including a handle, a spindle assembly, and a wire fixed to the handle and rotatably coupled to the spindle assembly.

FIG. 2 is a fragmentary perspective view according to an illustrative embodiment of a fluent material roller frame including the wire of FIG. 1 and an illustrative embodiment of a spindle assembly rotatably coupled to the wire.

FIG. 3 is a fragmentary plan view of the fluent material roller frame of FIG. 2.

FIG. 4 is a fragmentary cross-sectional view of the fluent material roller frame of FIG. 2, taken along line 4-4 of FIG. 2.

FIG. 5 is a perspective view according to another illustrative embodiment of a spindle assembly that may be coupled to the wire of FIG. 1.

FIG. 6 is a plan view of the spindle assembly of FIG. 5.

FIG. 7 is a cross-sectional view of the spindle assembly of FIG. 5, taken along line 7-7 of FIG. 5.

FIG. 8 is a fragmentary perspective view according to a further illustrative embodiment of a fluent material roller frame including the wire of FIG. 1 and a further illustrative embodiment of a spindle assembly rotatably coupled to the wire.

FIG. 9 is a fragmentary plan view of the fluent material roller frame of FIG. 8.

FIG. 10 is a fragmentary cross-sectional view of the fluent material roller frame of FIG. 8, taken along line 10-10 of FIG. 8.

FIG. 11 is a perspective view according to an additional illustrative embodiment of a spindle assembly that may be coupled to the wire of FIG. 1.

FIG. 12 is a plan view of the spindle assembly of FIG. 11.

FIG. 13 is a cross-sectional view of the spindle assembly of FIG. 11, taken along line 13-13 of FIG. 11.

FIG. 14 is an end view of the spindle assembly of FIG. 11, taken along line 14-14 of FIG. 12.

FIG. 15 is a perspective view according to a further illustrative embodiment of a spindle assembly that may be coupled to the wire of FIG. 1.

FIG. 16 is a plan view of the spindle assembly of FIG. 15.

FIG. 17 is a cross-sectional view of the spindle assembly of FIG. 15, taken along line 17-17 of FIG. 15.

FIG. 18 is a fragmentary perspective view according to an additional illustrative embodiment of a fluent material roller frame including a wire, and a spindle assembly that is rotatably carried on the wire and that includes a bearing, a chuck carried on the bearing, and a chuck retainer cap coupled to the bearing to retain the chuck.

FIG. 19 is a plan view of the wire and spindle assembly of FIG. 18.

FIG. 20 is a cross-sectional view of the wire and the bearing of the spindle assembly of FIG. 18, illustrating the bearing coupled to the wire.

FIG. 21 is a cross-sectional view of the wire and the bearing as shown in FIG. 20, and the chuck of the spindle assembly of FIG. 18, illustrating the chuck carried on the bearing.

FIG. 22 is a cross-sectional view of the wire and the spindle assembly of FIG. 18 carried on the wire, and illustrating the chuck coupled to the bearing by the chuck retainer cap, which is coupled to the bearing, and further illustrating a roller cover carried on the spindle assembly.

### DETAILED DESCRIPTION

In general, apparatuses will be described using one or more examples of illustrative embodiments of a spindle assembly for a fluent material roller that includes a cage or chuck rotatably carried on a bearing, wherein the roller frame spindle assembly may be used to adapt a roller frame from carrying a smaller roller to carrying a larger roller. The example embodiments will be described with reference to use with paint rollers. However, it will be appreciated as the description proceeds that the present disclosure is useful in many different applications where it is desirable to apply a fluent material to a surface via rolling. As used herein, the terminology “fluent material” broadly includes paints, stains, varnishes, strippers, sealers, dyes, waterproofers, and other like impotable liquid products, and even dry fluent material like powders, for example. Additionally, although the example embodiments are illustrated with respect to mini-rollers and jumbo mini-rollers, it will be appreciated as the description proceeds that the present disclosure is useful in larger applications of fluent material rollers, including, but not limited to standard roller sizes, for instance, with 9″ roller cages and roller covers, or of any other suitable sizes.

Also as used in herein, the terminology “for example,” “e.g., “for instance,” “like,” “such as,” “comprising,” “having,” “including,” and the like, when used with a listing of one or more elements, is to be construed as open-ended, meaning that the listing does not exclude additional elements. Additionally as used herein, permissive terms like “may” and “can” are expedients merely to indicate optionality, for instance, of a disclosed embodiment, element, feature, or the like, and should not be construed as rendering indefinite any disclosure herein. Moreover, directional words such as front, rear, top, bottom, upper, lower, radial, circumferential, axial, lateral, longitudinal, vertical, horizontal, transverse, and/or the like are employed by way of example and not necessarily limitation.

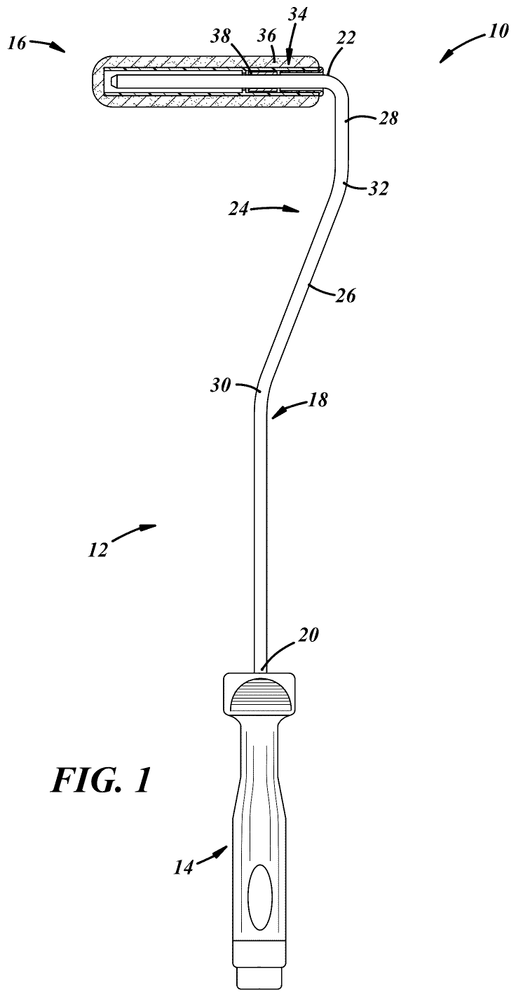

Referring specifically to the drawings, FIG. 1 shows an illustrative embodiment of a fluent material roller 10 including a roller frame 12 generally including a handle 14, a fluent material roller spindle assembly 16, and a wire 18 having a handle portion 20 coupled to the handle 14, a spindle shaft 22 on which the spindle assembly 16 is rotatably mounted, and an offset portion 24 between the handle portion 20 and the spindle shaft 22. As will be described in greater detail below, the roller frame 12 includes novel arrangements of spindle assemblies that allows roller frames to be converted from smaller roller sizes, for example, ¼″ inside diameter (ID), to larger roller sizes, for instance, ¾″ ID.

The handle 14 may be configured to be coupled to the wire 18 and to be grasped by a user's hand. For example, the handle 14 may include a component separate from the wire 18, and may have an inner passage (not shown) into which the wire 18 may be interference fit via assembly, or the handle 14 may be overmolded to the wire 18, or coupled thereto in any other suitable manner. In the illustrated example, the handle 14 may be composed of a polymeric material, but instead may be composed of a metal material, wood, or any other material suitable for use as a handle. In another example, the handle 14 may be a unitary part of the wire 18, for example, an enlarged portion of the wire 18, or a folded portion of the wire 18, or the like.

With continued reference to FIG. 1, “wire” is a term of art for a component that couples a handle to a spindle assembly and that component may or may not be produced from wire stock. Instead, the wire 18 may be cut and bent from bar stock, rod stock, or other like metal stock, or molded from polymeric material, printed from any suitable material, machined from any suitable material, or produced in any other manner suitable to yield a roller frame wire suitable to couple a handle to a spindle assembly. As shown in the drawings, the wire 18 may have a “7” shape, but in other embodiments the wire 18 may take on an “L” shape, any combination of a “7” shape and an “L” shape, or any other offset shape(s) suitable to couple a handle to a spindle assembly. The offset portion 24 may include a first section 26 that may extend away from the handle portion 20 of the wire 18, and a second section 28 that may extend away from the first section 26 and toward the spindle portion. The first section 26 may extend obliquely with respect to the handle portion 20 and the spindle shaft 22, and the second section 28 may extend substantially orthogonally (e.g. within plus or minus ten angular degrees) with respect to the handle portion 20 and the spindle shaft 22. The offset portion 24 also may include a first curved transition 30 between the first and second sections 26, 28, and a second curved transition 32 between the second section 28 and the spindle shaft 22. The spindle shaft 22 of the wire 18 may be smooth with no staked, swaged, or upset portions that are typically provided on conventional roller frame wires to retain a cage or spindle assembly thereon.

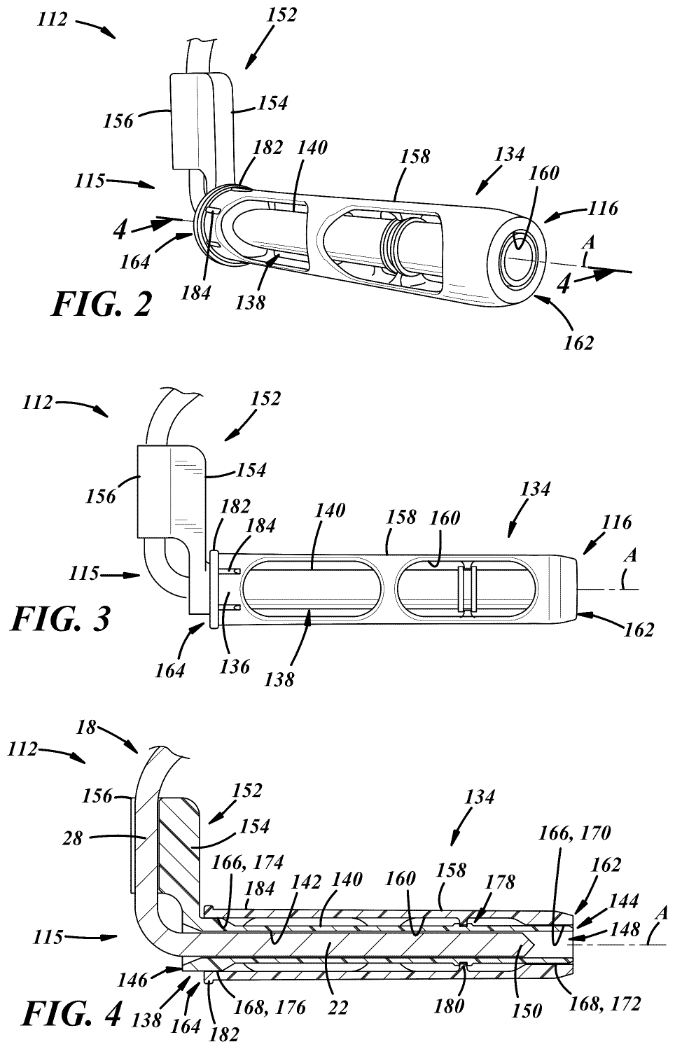

The spindle assembly 16 includes a core or spindle chuck (or “chuck”) 34 rotatably carried on the spindle shaft 22 of the wire 18. The chuck 34 includes a radially outer chuck surface 36 having an outer diameter (OD) to carry an inside diameter (ID) of a roller cover (not shown) thereon according to any suitable frictional fit therebetween. More specifically, the spindle assembly 116 may include a short bearing 38 directly coupled to the spindle shaft 22 of the wire 18 against relative rotation therebetween and establishing a rotational axis A, wherein the chuck 34 is rotatably carried an OD of the bearing 38 about the rotational axis A. The short bearing 38 has an axial length that is less than about 20% of an axial length of the chuck 34. The chuck 34 may be axially retained with respect to the spindle shaft 22 by a radially inwardly extending portion of the chuck 34 on one side of the short bearing 38 and by an end of a cap 35 inserted in an end of the chuck 34. In other embodiments chuck 34 may be axially trapped with respect to the spindle shaft 22 by a retaining ring, retaining washer, push-on nut, circlip, C-clip fastener, a pin-through-hole, or the like. In this embodiment, the roller cover ID may be nominally ¼″ or of any other suitable size. Accordingly, the OD of the chuck 34 likewise may be nominally ¼″ or of any other suitable size corresponding to the cover ID so as to ensure a frictional fit therebetween. As used herein the ID and OD sizes are nominal and may be specified to ensure any suitable frictional fit between the chuck OD and the roller cover ID. In any event, when it is desired to convert the fluent material roller 10 of FIG. 1 from a standard size roller cover or relatively smaller roller cover to a jumbo or relatively larger roller cover, the spindle assembly 16 may be removed and replaced with a larger spindle assembly, as discussed below with respect to FIGS. 2 through 22.

FIGS. 2-22 illustrate illustrative embodiments of fluent material roller frames. These embodiments are similar in many respects to the embodiment of FIG. 1 and to one another, and like numerals between the embodiments generally designate like or corresponding elements throughout the several views of the drawing figures. Accordingly, the descriptions of the embodiments are hereby incorporated into one another, and description of subject matter common to the embodiments generally may not be repeated.

With reference now to the embodiment of FIGS. 2-4, a fluent material roller frame 112 includes a spindle assembly 116 that may be used to replace the spindle assembly 16 of FIG. 1. The spindle assembly 116 includes a bearing 138 coupled to the spindle shaft 22 of the wire 18 against relative rotation therebetween and establishing a rotational axis A, and a chuck 134 rotatably carried on the bearing 138 about the rotational axis. Together, the spindle shaft 22 of the wire 18 and the spindle assembly 116 rotatably mounted on the spindle shaft 22 constitute a spindle 115 of the fluent material roller frame 112. The bearing 138 and the chuck 134 may be composed of polymeric materials, but may be composed of metal(s), or any other material(s) suitable for use with a fluent material roller.

With reference now to FIG. 4, the bearing 138 includes a radially outer bearing surface 140 circumscribing the rotational axis, a radially inner bearing surface 142 circumscribing the rotational axis, an axially outboard bearing end 144, and an axially inboard bearing end 146. The radially outer and inner bearing surfaces 140, 142 may be cylindrical. The bearing 138 includes a throughbore 148 extending between the axially outboard and inboard bearing ends 144, 146 and establishing the radially inner bearing surface 142, and wherein the outboard bearing end 144 extends axially beyond an axial outboard spindle shaft end 150 of the spindle shaft 22 of the wire 18. Notably, although the bearing 138 is fixed to the offset portion 24 of the wire 18, the bearing 138 is not and need not be fixed to the spindle shaft 22 of the wire 18.

Instead, the bearing 138 also includes a retention arm 152 extending radially outwardly and coupled to the offset portion 24 of the wire 18. In the illustrated embodiment, the retention arm 152 has a base portion 154 that projects away from the radially outer bearing surface 140 and a clip portion 156 that extends transversely away from the base portion 154 in an axially inboard direction and establishes a frame wire channel in which the wire 18 is clipped. The retention arm 152 may extend away from the radially outer bearing surface 140 proximate the axially inboard bearing end 146. As used herein, the term “proximate” means located at or closer to an end of a component than to an opposite end of the component. The retention arm 152 may be disposed at an orthogonal angle with respect to the axis A as shown, or at an oblique angle to enable the arm 152 to be clipped to an obliquely angled portion of an offset portion of a wire. Accordingly, the retention arm 152 may be clipped to any portion of the wire 18 besides the spindle shaft 22. In any event, the clip portion 156 of the retention arm 152 prevents the spindle assembly 116 from sliding off of the spindle shaft 22 of the wire 18. The base portion 154 of the retention arm 152 may be of a thickness measured along the axial direction that is sufficient to withstand impact against an edge, such as an edge of a garbage can, when a user ejects a roller cover by smacking the fluent material roller frame 112 against the edge as users are known to do. For example, and in relative terms, the thickness may be at least as thick as the diameter of the wire 18, or at least as thick as the clip portion 156. In absolute terms, the thickness may be at least 2 mm.

With continued reference to FIGS. 2-4, the chuck 134 includes a radially outer chuck surface 158 circumscribing the rotational axis A, a radially inner chuck surface 160 circumscribing the rotational axis A, an axially outboard chuck end 162, and an axially inboard chuck end 164. The radially outer and inner chuck surfaces 158, 160 may be cylindrical.

With particular reference to FIG. 4, a bearing portion 166 of the radially inner chuck surface 160 is carried on a corresponding chuck portion 168 of the radially outer bearing surface 140. More specifically, an axial outboard bearing portion 170 of the radially inner chuck surface 160 is carried on a corresponding axial outboard chuck portion 172 of the radially outer bearing surface 140 proximate the axially outboard bearing and chuck ends 144, 162 of the bearing 138 and chuck 134, and an axial inboard bearing portion 174 of the radially inner chuck surface 160 is carried on a corresponding inboard chuck portion 176 of the radially outer bearing surface 140 proximate the axially inboard bearing and chuck ends 146, 164 of the bearing 138 and chuck 134. Corresponding diameters of the inboard bearing portions 174, 176 may be greater than corresponding diameters of the outboard bearing portions 170, 172.

With reference again to FIGS. 2-4, the chuck 134 may be axially retained on the bearing 138. For example, the bearing 138 also may include a chuck axial locator 178 and the chuck 134 may include a bearing axial locator 180 that engages the chuck axial locator 178 to axially locate the chuck 134 on the bearing 138. More specifically, the chuck axial locator 178 may include radially outwardly extending ribs that may be axially spaced apart from one another, and the bearing axial locator 180 may include a radially inwardly extending rib between the radially outwardly extending ribs. The chuck 134 also may include a roller cover axial locator 182 that may include a wall extending radially outwardly at the axially inboard chuck end 164, and a roller cover retainer 184 that may include a plurality of ribs at a location outboard of the roller cover axial locator 182, extending axially away from the roller cover axial locator 182, extending radially outwardly, and being circumferentially spaced apart from one another. In this embodiment, the ribs may be unitary with a radially outer surface 136 of the chuck 134.

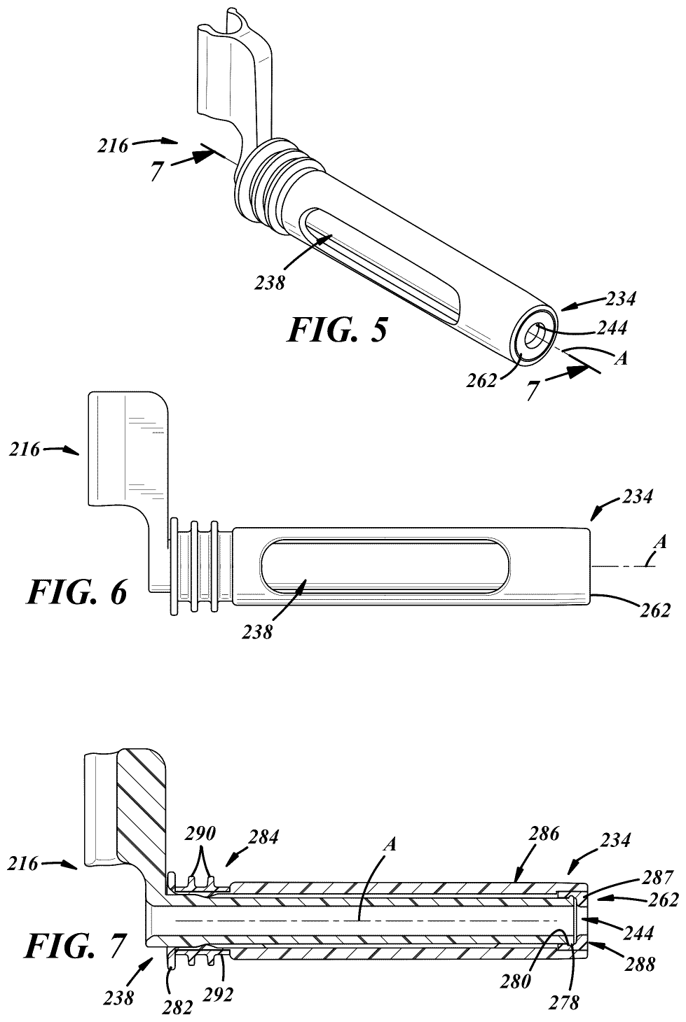

With reference now to the embodiment of FIGS. 5-7, another spindle assembly 216 may be used to replace the spindle assembly 16 of FIG. 1. The spindle assembly 216 includes a bearing 238 configured to be coupled to a spindle shaft of a wire (not shown) against relative rotation therebetween and establishing a rotational axis A, and a chuck 234 rotatably carried on the bearing 238 about the rotational axis A. The spindle assembly 216 is substantially similar to the spindle assembly 116 of FIGS. 2-4, with a few differences, as follows. Here, with reference to FIG. 7, the bearing 238 includes a chuck axial locator 278 at or proximate an axial outboard bearing end 244 of the bearing 238 and that may be in the form of a radially extending rib. Also, the chuck 234 is a multi-piece chuck including a chuck main body 286 having an opening 287 at an axially outboard chuck end 262, and a chuck retainer plug 288 carried in the opening 287 of the chuck main body 286. The chuck retainer plug 288 may be frictionally fit to the chuck main body 286, threaded thereto, snap fit thereto, or coupled in any other suitable manner thereto. The chuck retainer plug 288 includes a bearing axial locator 280 configured to be coupled to the chuck axial locator 278 and may be in the form of a circumferentially extending groove to accept the radially extending rib of the bearing 238. Additionally, a roller cover retainer 284 includes one or more elastomeric fins 290 that extend radially outwardly. The fins 290 may be axially spaced apart from one another and may be part of a sleeve 292. In an embodiment, the sleeve 292 may be a component separate from the main body 286 of the chuck 234 that may be stretched over an axial outboard portion of the main body 286 of the chuck 234 and carried in a depression of the main body 286 between the outboard portion and a roller cover axial locator 282. In another embodiment, the sleeve 292 may be overmolded to, or co-molded with, the main body 286 of the chuck 234. When a roller cover (not shown) is assembled over the spindle assembly 216, the one or more fins 290 also may act as a seal to curtail leakage of fluent material between the chuck 234 and the roller cover.

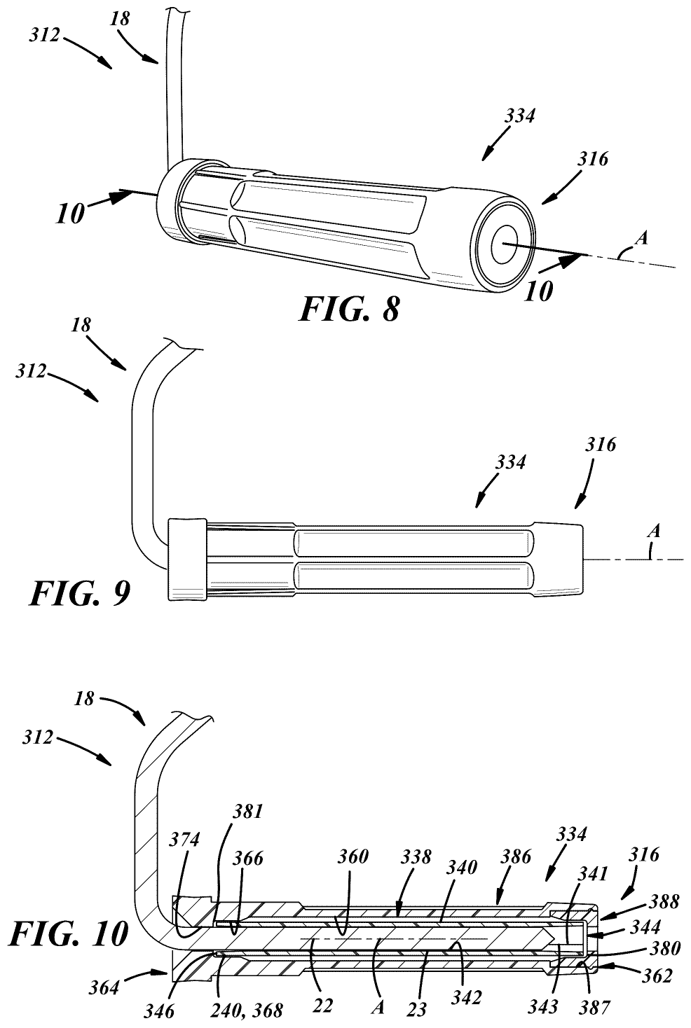

With reference now to the embodiment of FIGS. 8-10, a fluent material roller frame 312 includes a spindle assembly 316 that may be used to replace the spindle assembly 16 of FIG. 1 and that is coupled to the wire 18 thereof. With more specific reference to FIG. 10, the spindle assembly 316 includes a bearing 338 coupled to the spindle shaft 22 of the wire 18 against relative rotation therebetween and establishing a rotational axis A, and a chuck 334 rotatably carried on the bearing 338 about the rotational axis A. Here, the bearing 338 is retained on the spindle shaft 22 of the wire 18 via a frictional fit. For example, the bearing 338 also includes circumferentially opposed ends 341, 343 establishing a longitudinal split of the bearing 338 to facilitate resilient expansion and contraction of the bearing 338, which may have an ID smaller than an OD of the spindle shaft 22 of the wire 18 to establish the frictional fit. The bearing 338 thus may be a diametrically expanding tube component that may serve to both rotatably carry the chuck 334 but also axially retain the spindle assembly 316 to the wire 18 via friction between a radially inner bearing surface 342 of the bearing 338 and a radially outer surface 23 of the spindle shaft 22 of the wire 18. The bearing 338 may be composed, sized, and/or otherwise configured such that a user can pull the bearing 338 off of the wire 18 by hand.

Like the chuck 134 of FIGS. 5-7, here the chuck 334 illustrated in FIGS. 8-10 also is a multi-piece chuck including a chuck main body 386 having an opening 387 at an axially outboard chuck end 362, and a chuck retainer plug 388 carried in the opening 387 of the chuck main body. Here, however, a first inboard bearing portion 366 of a radially inner chuck surface 360 is carried on a corresponding inboard chuck portion 368 of a radially outer bearing surface 340 of the bearing 338, and a second inboard bearing portion 374 of the radially inner chuck surface 360 is spaced radially away from the spindle shaft 22 of the wire 18. The second inboard bearing portion 374 is located axially outboard of the first inboard bearing portion 366. Unlike the spindle assembly 216 of FIGS. 5-7, here the chuck 334 may be axially retained with respect to the bearing 338 by an axial outboard bearing axial locator 380 at the axially outboard chuck end 362 of the chuck 334 in the form of a radially inwardly extending portion of the chuck retainer plug 388 that contacts an axially outboard bearing end 344 of the bearing 338, and by an inboard bearing axial locator 381 at or proximate an axially inboard chuck end 364 of the chuck 334 in the form of a radially inwardly extending portion of the chuck main body 386 that contacts an axially inboard bearing end 346 of the bearing 338.

The bearing 338 may have an axial length that is at least ½ of an axial length of the chuck 334. More specifically, the bearing 338 may have an axial length that is at least ⅔ of an axial length of the chuck 334. Moreover, the bearing 338 may have an axial length that is at least ½ (50%) of an axial length of the spindle shaft 22 of the wire 18 and, more specifically, at least ⅔ of the axial length of the spindle shaft 22. In fact, in the embodiment illustrated in FIGS. 8-10, the bearing 338 is axially longer than the spindle shaft 22. In absolute terms, the axial length of the bearing 338 may be between 2″ and 4″ and, more particularly, between 2.5″ and 3.5″. It was discovered that the relatively long engagement length between the bearing 338 and the spindle shaft 22 enables retention of the spindle assembly 316 on the spindle shaft 22 of the wire, even though no separate retainer, pin, or other fastener is used to retain the spindle assembly 316, and even though a user knocks the roller against an edge of a garbage can to dislodge and release a roller cover from the roller. In other words, the roller cover gets knocked off the roller, whereas the spindle assembly 216 stays retained on the roller.

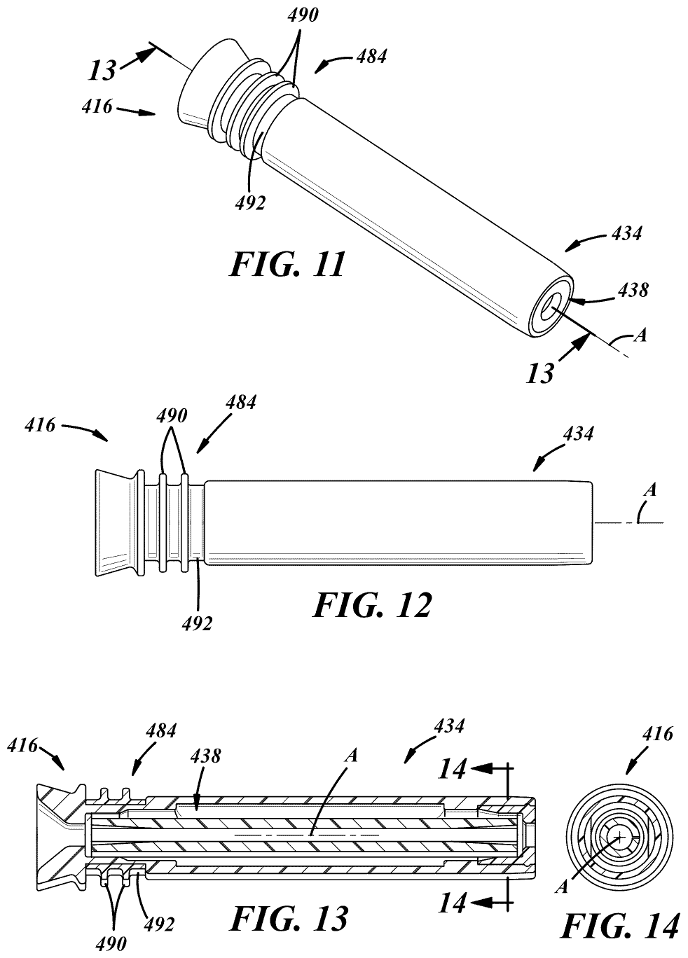

With reference now to the embodiment of FIGS. 11-14, a spindle assembly 416 may be used to replace the spindle assembly 16 of FIG. 1. With more specific reference to FIG. 13, the spindle assembly 416 includes a bearing 438 adapted to be coupled to the spindle shaft 22 of the wire 18 against relative rotation therebetween and establishing a rotational axis A, and a chuck 434 rotatably carried on the bearing 438 about the rotational axis A. Here, the spindle assembly 416 is substantially similar to the spindle assembly 316 of FIGS. 8-10, with one main difference, as follows. Here, a roller cover retainer 484 includes one or more elastomeric fins 490 that extend radially outwardly, and the fins 490 may be axially spaced apart from one another and may be part of a sleeve 492.

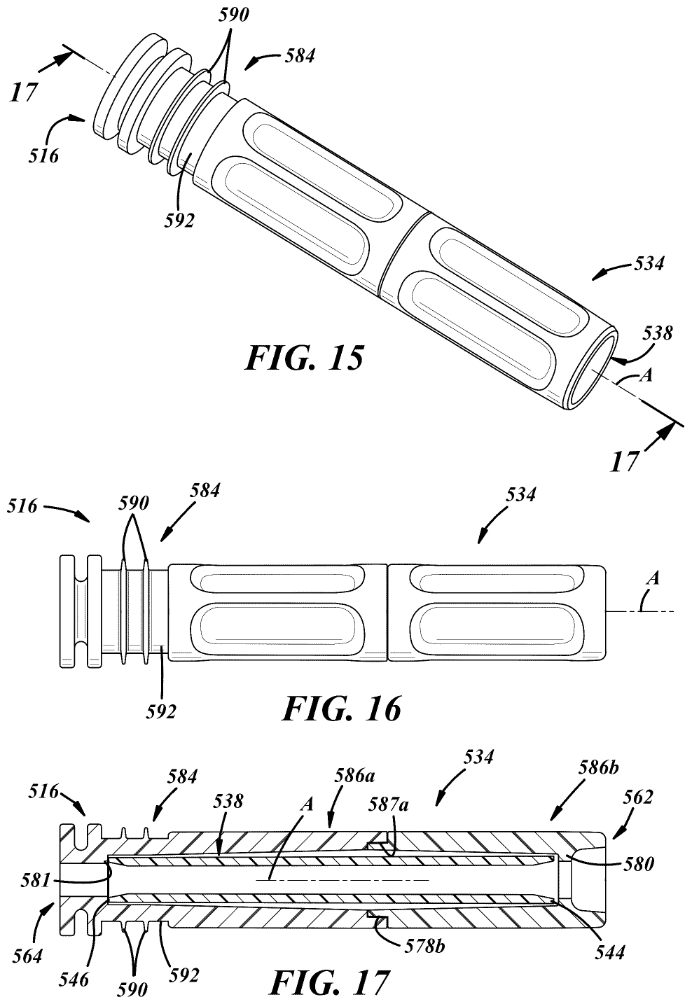

With reference now to the embodiment of FIGS. 15-17, a spindle assembly 516 may be used to replace the spindle assembly 16 of FIG. 1. With more specific reference to FIG. 17, the spindle assembly 516 includes a bearing 538 adapted to be coupled to the spindle shaft 22 of the wire 18 against relative rotation therebetween and establishing a rotational axis A, and a chuck 534 rotatably carried on the bearing 438 about the rotational axis A. The spindle assembly 516 includes a chuck main body that may be comprised of a first main body portion 586a, and a second main body portion 586b coupled to the first main body portion 586a. The second main body portion 586b may be a distal portion. The first main body portion 586a may include a first coupling portion 587a, and the second main body portion 586b may include a second coupling portion 587b coupled to the first coupling portion 587a. The first and second coupling portions 587a,b may be threaded couplings for threading the main body portions 586a,b together, or may be snap-fit couplings, press-fit couplings, welded coupling, adhered couplings, or any other suitable couplings. The chuck 534 may be axially retained with respect to the bearing 538 by an axial outboard bearing axial locator 580 at an axially outboard chuck end 562 of the chuck 534 in the form of a radially inwardly extending portion of the second main body portion 586 of the chuck 534 that contacts an axially outboard bearing end 544 of the bearing 538, and by an inboard bearing axial locator 581 at or proximate an axially inboard chuck end 564 of the chuck 534 in the form of a radially inwardly extending portion of the first main body portion 586a that contacts an axially inboard bearing end 546 of the bearing 538. The first main body portion 586a may include or may carry a roller cover retainer 584 that includes one or more fins 590 that extend radially outwardly, and the fins 590 may be axially spaced apart from one another and may be part of a sleeve 592. In this illustrated embodiment and in the other embodiments, an axial length of the bearing 538 may be at least 50% of an axial length of the chuck 534 for good frictional retention of the bearing 538 on the spindle shaft. More specifically, the axial length of the bearing 538 may be between 50% and 100% of the length of the chuck 534 and, even more specifically, may be between 65% and 85% of the length of the chuck 534.

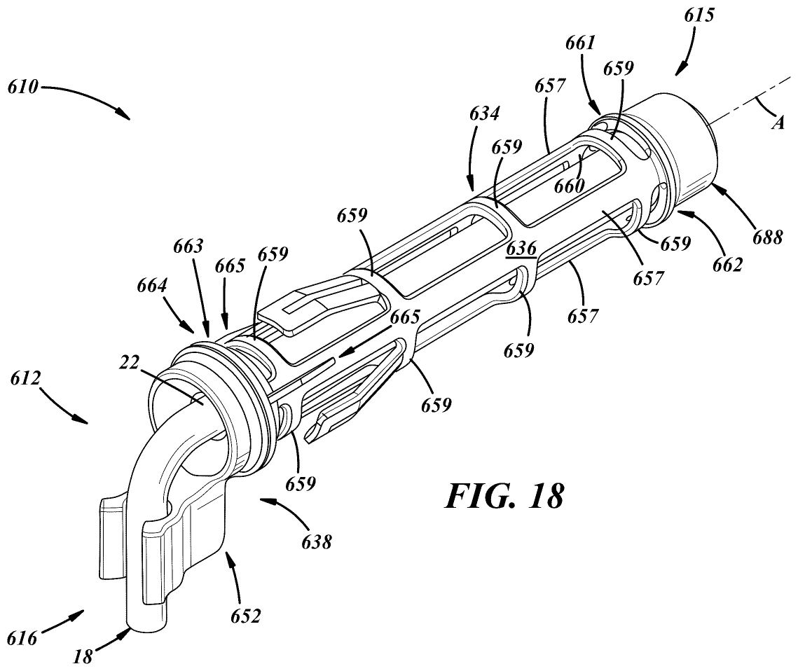

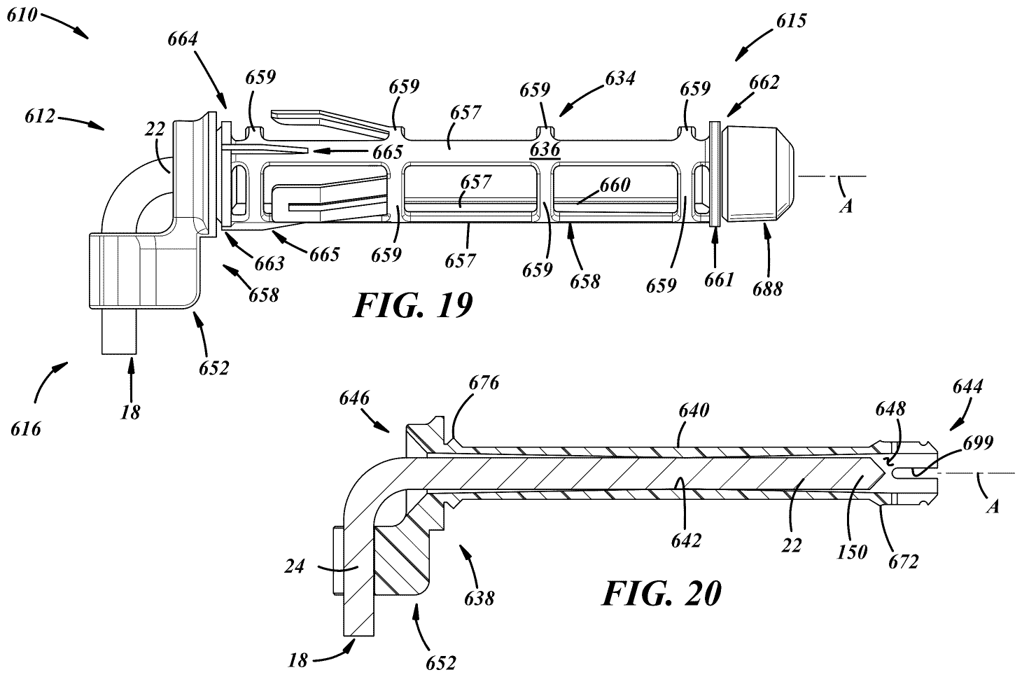

With reference now to the embodiment of FIGS. 18 and 19, another spindle assembly 616 may be used to replace the spindle assembly 16 of FIG. 1, wherein another illustrative embodiment of a fluent material roller 610 includes a roller frame 612 generally including the spindle assembly 616, and the wire 18 having the spindle shaft 22 on which the spindle assembly 616 is rotatably mounted. The spindle assembly 616 includes a core or spindle chuck (or “chuck”) 634 rotatably carried on the spindle shaft 22 of the wire 18. The chuck 634 includes a radially outer chuck surface 636 having an outer diameter (OD) to carry an inside diameter (ID) of a roller cover R (FIG. 22) thereon according to any suitable frictional fit therebetween. More specifically, the spindle assembly 616 may include a bearing 638 directly coupled to the wire 18 against relative rotation therebetween and establishing a rotational axis A, wherein the chuck 634 is rotatably carried an OD of the bearing 638 about the rotational axis A. Together, the spindle shaft 22 of the wire 18 and the spindle assembly 616 rotatably mounted on the spindle shaft 22 constitute a spindle 615 of the fluent material roller frame 612. The spindle assembly 616 also may include a chuck retainer cap 688 that may be coupled to the bearing 638 as will be described in greater detail below.

With reference now to FIG. 20, the bearing 638 includes a radially outer bearing surface 640 circumscribing the rotational axis A, a radially inner bearing surface 642 circumscribing the rotational axis A, an axially outboard bearing end 644, and an axially inboard bearing end 646. The radially outer and inner bearing surfaces 640, 642 may or may not be strictly cylindrical. For example, the radially inner bearing surface 642 may be hourglass shaped, wherein axially outboard and inboard bearing portions have a larger diameter than an intermediate or central portion therebetween, such that the inner diameter becomes smaller toward the center or intermediate portion of the bearing 638. In this example, and as illustrated, the radially inner bearing surface 642 is tapered radially outwardly from the intermediate or central portion toward both axially outward and axially inward directions.

The bearing 638 includes a throughbore 648 extending between the axially outboard and inboard bearing ends 644, 646 and establishing the radially inner bearing surface 642, and wherein the outboard bearing end 644 extends axially beyond the outboard spindle shaft end 150 of the spindle shaft 22 of the wire 18. Notably, although the bearing 638 is fixed to the offset portion 24 of the wire 18, the bearing 638 need not be affirmatively fixed to the spindle shaft 22 of the wire 18 other than perhaps frictional engagement. Instead, the bearing 638 also includes a retention arm 652 extending radially outwardly and coupled to the offset portion 24, more particularly, the second section 28, of the wire 18. Accordingly, the bearing 638 may be retained to the wire 18 at only the intermediate or central portion of the bearing 638 and the retention arm 652 for a two-location coupling between the bearing 638 and the wire 18. The retention arm 652 may be like those already described above with reference to FIGS. 2-7.

With reference again to FIGS. 18-19, the chuck 634 may include an open lattice frame, including beams 657 that may be circumferentially spaced apart from one another and may extend predominantly longitudinally, and ribs 659 that may be longitudinally spaced apart from one another and may extend predominantly circumferentially between the beams 657. The beams 657 and/or the ribs 659 may establish the radially outer chuck surface 636 circumscribing the rotational axis A, with openings between the beams 657 and the ribs 659. The chuck 634 also may include a radially inner chuck surface 660 circumscribing the rotational axis A, an axially outboard chuck end 662, and an axially inboard chuck end 664. The chuck 634 further may include an axially outboard flange 661 at the axially outboard chuck end 662, and an axially inboard flange 663 at the axially inboard chuck end 664. The flanges 661, 663 may extend radially outwardly from the beams 657, and may axially terminate the chuck 634 at both ends 662, 664. The chuck 634 further may include roller cover radial locators 665 that may extend predominantly longitudinally along the beams 657 proximate the axially inboard chuck end 664, and may be unitary with the beams 657 and with the axially inboard flange 663. The locators 665 may be three in quantity and may be equidistantly circumferentially spaced apart from one another. The locators 665 may include obliquely angled ramp portions protruding longitudinally and axially away from the outer surface 658, and cylindrical portions extending from the ramp portions to the axially inboard flange 663. The locators 665 help axially and circumferentially secure the roller cover R (FIG. 22) during use of the roller 610, and may help prevent the roller cover R from inadvertently sliding off of the chuck 634.

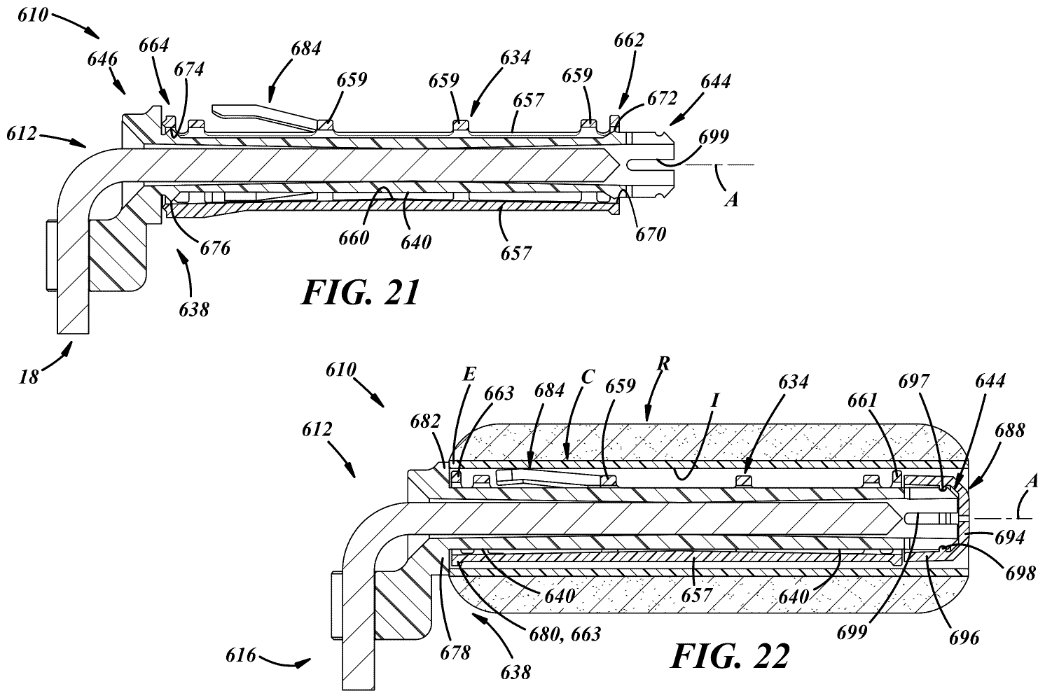

With reference now to FIG. 21, the chuck 634 may be slid axially onto the bearing 638. For example, axially outboard and inboard bearing portions 670, 674 of the radially inner chuck surface 660 are carried on corresponding outboard and inboard chuck portions of the radially outer bearing surface 640 to establish two radial contact locations between the chuck 634 and the bearing 638 to reduce surface area and drag therebetween. More specifically, the axially outboard bearing portion 670 of the radially inner chuck surface 660 is carried on a corresponding outboard chuck portion 672 of the radially outer bearing surface 640 proximate the axially outboard bearing and chuck ends 644, 662 of the bearing 638 and chuck 634, and an axially inboard bearing portion 674 of the radially inner chuck surface 660 is carried on a corresponding inboard chuck portion 676 of the radially outer bearing surface 640 proximate the axially inboard bearing and chuck ends 646, 664 of the bearing 638 and the chuck 634. The inboard and outboard chuck portions 672, 674 of the radially outer bearing surface 640 may be established by triangularly-shaped (in cross-section) projections, for example, by vertices of those projections. Corresponding diameters of the inboard bearing portions 674, 676 may be greater than corresponding diameters of the outboard portions 670, 672. Also, there is a relatively large radial gap between the chuck 634 and the bearing 638 to allow the chuck 634 to spin freely about the bearing 638 and to facilitate cleaning. Moreover, the chuck 634 includes friction tabs or roller cover retainers 684 that are in a fully radially extended position in FIG. 21 and that are provided to retain the roller cover R (FIG. 22) thereon, as will be described further herein below.

With reference now to FIG. 22, the chuck 634 may be axially retained on the bearing 638. For example, the bearing 638 also may include a chuck axial locator 678 and the chuck 634 may include a bearing axial locator 680 that engages the chuck axial locator 678 to axially locate the chuck 634 on the bearing 638. More specifically, the chuck axial locator 678 of the bearing 638 may include a wall extending radially away from the radially outer bearing surface 640 of the bearing 638, and the bearing axial locator 680 of the chuck 634 may include the axially inboard flange 663 that may locate against the corresponding wall of the chuck axial locator 678. The bearing 638 also may include a roller cover axial locator 682 that may include a radially outward portion of the wall of the chuck axial locator 678 extending radially outwardly from the chuck axial locator 678 at the axially inboard chuck end 664.

At the axially outboard bearing end 644 of the bearing 638, the chuck retainer cap 688 may be frictionally fit to the outboard bearing end 644, threaded thereto, snap fit thereto, or coupled in any other suitable manner thereto. More specifically, the chuck retainer cap 688 may include an end wall 694, a cylindrical skirt 696 extending away from the end wall 694, and at least one rib 698 that may extend radially inwardly from a radially inner surface of the skirt 696 and that may extend circumferentially around the inside of the skirt 696. The rib 698 may engage correspondingly with at least one groove 697 in the bearing 638 proximate the outboard bearing end 644 of the bearing 638. Of course, the rib 698 and the groove 697 may be reversed on the respective components. The outboard end of the bearing 638 may include one or more open slots 699 therein to facilitate resilient flexure of portions of the bearing 638 to facilitate snap fit of the cap 688 to the bearing 638. In any case, the cap 688 may axially retain the chuck 634 with respect to the bearing 638, while still allowing the chuck 634 to rotate on the bearing 638. In other embodiments, the chuck 634 may be axially retained with respect to the bearing 638 by a retaining ring, retaining washer, push-on nut, circlip, C-clip fastener, a pin-through-hole, or the like in any other suitable manner. An outermost diameter of the cap 688 may be less than an innermost diameter of the roller cover R. The cap 688 may be sized to be axially coextensive with the roller cover R, such that the cap 688 does not protrude axially beyond the roller cover R when the roller cover R is located against the roller cover axial locator 682 of the bearing 638.

With continued reference to FIG. 22, the roller cover R may be carried on and coupled to the spindle assembly 616. More specifically, a core C of the roller cover R may have an axially inboard end E located against the roller cover axial locator 682 of the bearing 638, and a radially inner surface I located against roller cover radial retainers 684 of the chuck 634 and the roller cover radial locators 665 (FIG. 18). The roller cover radial retainers 684 may extend radially outwardly away from the radially outer chuck surface 636 and in an axially inboard direction. The roller cover radial retainers 684 may include cantilevered arms having fixed ends coupled to corresponding ribs 659 of the chuck 634, obliquely angled ramps extending radially outwardly and longitudinally rearwardly, and cylindrical lands extending longitudinally rearwardly toward the inboard end 664 of the chuck 634 and terminating in free ends. The roller cover radial retainers 684 may be circumferentially interdigitated with the roller cover radial locators 665 (FIG. 18), and may be configured to impose a yieldable radially outward force on the core C of the roller cover R to help retain the roller cover R on the chuck 634. The various features of the chuck 634 are configured to impose a holding force on the roller cover R that is less than an amount of force required to remove the bearing 638 from the wire 18. Accordingly, when a user hits the wire 18 against an edge of a garbage can or other structure, the roller cover R will slide off of the chuck 634 before the bearing 638 ever dislodges from the wire 18.

Contrary to conventional fluent material rollers that are dedicated to carrying one size of roller cover, the presently disclosed subject matter facilitates use of a universal or common roller frame handle and wire that can accept and rotatably carry roller covers of different sizes. In a specific example, the user can use the same frame handle and wire to accept and carry a mini-roller cover and a jumbo mini-roller cover by changing out a mini-roller spindle assembly for a jumbo roller spindle assembly. Accordingly, there is no need for a user to have to purchase two separate fluent material rollers as has previously been done.

Finally, the subject matter of this application is presently disclosed in conjunction with several explicit illustrative embodiments and modifications to those embodiments, using various terms. All terms used herein are intended to be merely descriptive, rather than necessarily limiting, and are to be interpreted and construed in accordance with their ordinary and customary meaning in the art, unless used in a context that requires a different interpretation. And for the sake of expedience, each explicit illustrative embodiment and modification is hereby incorporated by reference into one or more of the other explicit illustrative embodiments and modifications. As such, many other embodiments, modifications, and equivalents thereto, either exist now or are yet to be discovered and, thus, it is neither intended nor possible to presently describe all such subject matter, which will readily be suggested to persons of ordinary skill in the art in view of the present disclosure. Rather, the present disclosure is intended to embrace all such embodiments and modifications of the subject matter of this application, and equivalents thereto, as fall within the broad scope of the accompanying claims.

1. A fluent material roller frame, comprising:
a handle;
a spindle assembly; and
a wire having a handle portion coupled to the handle, a spindle shaft on which the spindle assembly is rotatably mounted, and an offset portion between the handle portion and the spindle shaft,
wherein the spindle assembly includes
a bearing coupled to the spindle shaft of the wire against relative rotation therebetween and establishing a rotational axis and including
a radially outer bearing surface circumscribing the rotational axis,
a radially inner bearing surface circumscribing the rotational axis,
an axially outboard bearing end, and
an axially inboard bearing end; and
a chuck rotatably carried on the bearing about the rotational axis and including
a radially outer chuck surface circumscribing the rotational axis,
a radially inner chuck surface circumscribing the rotational axis,
an axially outboard chuck end, and
an axially inboard chuck end,
wherein a bearing portion of the radially inner chuck surface of the chuck is carried on a corresponding chuck portion of the radially outer bearing surface of the bearing.

2. The fluent material roller frame of claim 1, wherein the bearing includes a retention arm extending radially outwardly and coupled to the offset portion of the wire.

3. The fluent material roller frame of claim 2, wherein the retention arm has a base portion that projects away from the radially outer bearing surface and a clip portion that extends transversely away from the base portion in an axially inboard direction and establishes a frame wire channel in which the wire is clipped therein.

4. The fluent material roller frame of claim 2, wherein the bearing is coupled to the wire only by the retention arm and an intermediate portion of the radially inner bearing surface between the axially outboard and inboard bearing ends.

5. The fluent material roller frame of claim 1, wherein the bearing includes a throughbore extending between the axially inboard and outboard bearing ends and establishing the radially inner bearing surface, and wherein the outboard bearing end extends axially beyond an axial outboard spindle shaft end of the spindle shaft of the wire.

6. The fluent material roller frame of claim 1, wherein the spindle shaft of the wire is smooth with no staked, swaged, or upset portions.

7. The fluent material roller frame of claim 1, wherein the bearing is retained on the spindle shaft of the wire via a frictional fit, wherein the bearing also includes circumferentially opposed ends establishing a longitudinal split of the bearing to facilitate the frictional fit.

8. The fluent material roller frame of claim 1, wherein the bearing has an axial length that is at least 50% of an axial length of the spindle shaft of the wire.

9. A fluent material roller spindle assembly, comprising:
a bearing establishing a rotational axis and including
a radially outer bearing surface circumscribing the rotational axis,
a radially inner bearing surface circumscribing the rotational axis,
an axially outboard bearing end, and
an axially inboard bearing end; and
a chuck rotatably carried on the bearing about the rotational axis and including
a radially outer chuck surface circumscribing the rotational axis,
a radially inner chuck surface circumscribing the rotational axis,
an axially outboard chuck end, and
an axially inboard chuck end,
wherein a bearing portion of the radially inner chuck surface of the chuck is carried on a corresponding chuck portion of the radially outer bearing surface of the bearing.

10. The fluent material roller spindle assembly of claim 9, wherein the bearing includes a retention arm extending away from the radially outer bearing surface proximate the axially inboard bearing end, and the bearing and chuck portions are located axially outboard of the retention arm.

11. The fluent material roller spindle assembly of claim 9, wherein an axial outboard bearing portion of the radially inner chuck surface is carried on a corresponding axial outboard chuck portion of the radially outer bearing surface proximate the axially outboard bearing end of the bearing and the axially outboard chuck end of the chuck, and/or wherein an axial inboard bearing portion of the radially inner chuck surface is carried on a corresponding axial inboard chuck portion of the radially outer bearing surface proximate the axially outboard bearing end of the bearing and the axially outboard chuck end of the chuck.

12. The fluent material roller spindle assembly of claim 9, wherein axial outboard and inboard bearing portions of the radially inner chuck surface are carried on corresponding axial outboard and inboard chuck portions of the radially outer bearing surface.

13. The fluent material roller spindle assembly of claim 9, wherein an axial outboard bearing portion of the radially inner chuck surface is carried on a corresponding outboard chuck portion of the radially outer bearing surface proximate the axially outboard bearing end of the bearing and the axially outboard chuck end of the chuck, and an inboard bearing portion of the radially inner chuck surface is carried on a corresponding inboard chuck portion of the radially outer bearing surface proximate the axially outboard bearing end of the bearing and the axially outboard chuck end of the chuck, and wherein corresponding diameters of the inboard bearing portions are greater than corresponding diameters of the axial outboard bearing portions.

14. The fluent material roller spindle assembly of claim 9, wherein the bearing also includes a chuck axial locator and the chuck includes a bearing axial locator that engages the chuck axial locator to axially locate the chuck on the bearing.

15. The fluent material roller spindle assembly of claim 9, wherein the bearing includes a chuck axial locator and a roller cover axial locator that extends radially outward from the chuck axial locator.

16. The fluent material roller spindle assembly of claim 9, wherein the chuck also includes
a roller cover axial locator including a wall extending radially outwardly at the axially inboard chuck end, and
a roller cover retainer including at least one elastomeric fin extending radially outwardly at a location outboard of the roller cover axial locator.

17. The fluent material roller spindle assembly of claim 9, wherein the chuck also includes
a plurality of circumferentially spaced roller cover radial locators, and
a plurality of circumferentially spaced roller cover radial retainers circumferentially interdigitated with the plurality of circumferentially spaced roller cover radial locators, and extending radially outwardly from the radially outer chuck surface and in an axially inboard direction and terminated in free ends.

18. The fluent material roller spindle assembly of claim 9, wherein the chuck also includes
a chuck main body having an opening at the axially outboard chuck end, and
a chuck retainer plug carried in the opening of the chuck main body.

19. The fluent material roller spindle assembly of claim 9, further comprising a chuck retainer cap coupled to the bearing to axially retain the chuck with respect to the bearing.

20. The fluent material roller spindle assembly of claim 9, wherein the bearing also includes circumferentially opposed ends establishing a longitudinal split of the bearing.
